(19) United States
(12) Patent Application Publication
(10) Pub. No.: US 2021/0131469 A1
(43) Pub. Date: May 6, 2021

(54) Panel connector

(71) Applicant: William Simpson, Independence, VA (US)

(72) Inventor: William Simpson, Independence, VA (US)

(21) Appl. No.: 17/089,809

(22) Filed: Nov. 5, 2020

Related U.S. Application Data
(60) Provisional application No. 62/931,271, filed on Nov. 6, 2019.

(51) Int. Cl. F16B 12/50

(52) U.S. Cl. CPC F16B 12/50

(57) ABSTRACT

The disclosed device is a connector that slides into a T-slot in a first panel, and a stepped slot in a second panel. The connector includes a perpendicular head to lock into the T-slot, and an upward protrusion to slide into the stepped slot. A protrusion locks into a depression with the stepped slot, locking the connector in place.

### CROSS-REFERENCE TO RELATED APPLICATION

This application is a continuation/continuation-in-part of U.S. Pat. App. Ser. No. 62/931,271, filed Nov. 6, 2019, titled Panel connector.

### FIELD

This invention relates to the field of cabinetry and more particularly to a device and method for the connection of panels.

### BACKGROUND

Cabinetry and furniture are commonly constructed using sheet goods, such as plywood. The sheet goods are used to form boxes, typically with edges joined at ninety-degree angles. Sheet goods are much larger than their thickness, often sold in 96″×48″ panels, with thickness of ⅜″, ½″, ⅝″, or ¾″, in English sizes, and similar dimensions in Metric sizes.

Joining sheet goods at a ninety-degree angle causes the two sheets to form a T or L shape. Thus, the narrow thickness, such as ½″, is all the thickness presented to make a joint.

While complex ways, such as dovetail joints, exist to address this issue, dovetail joints are complex to cut. Mechanical connectors, such as screws, provide insufficient strength for many applications.

What is needed is a device and method of joining sheet goods that is simple to install but creates strong joints.

### SUMMARY

The disclosed device is a connector that slides into a T-slot in a first panel, and a stepped slot in a second panel. The connector includes a perpendicular head to lock into the T-slot, and an upward protrusion to slide into the stepped slot. A tab locks into a depression with the stepped slot, locking the connector in place.

In an alternative embodiment, the slot in the second panel is not stepped, but has non-stepped sides. This allows the connector to be inserted through the top face of the panel, rather than the edge.

Thus, installation into a first panel is via a routed depression in an edge, into which the connector slides.

Installation into the second panel is by sliding into a slot. The item is slid into the slot either at an edge, or through a hole formed in the face of the panel, allowing installation of the connector through the face, then slid into position.

The above device can be shaped in multiple ways, but with common features of being readily removable and easy to install.

The connector is preferably constructed with a downwardly protruding locking tab. Alternatively, the tab protrudes outward, allowing the connector to lock into a recess when the connector is inserted through the face of the panel, rather than the edge.

Note that the listed dimensions within are for reference only based on a typical connector size. The connector can be scaled up or down, as well as proportions changed, without affecting the function.

To install the first embodiment, first the two panels are prepared.

To prepare the first panel:
Use a T-slot bit to cut a pocket the same shape as the device to a depth of 5/16″.
For the edge-inserted embodiment:
   At the tip of the shape, using the same T-slot bit, route a small depression approximately ½″ long× 3/16″ deep;
      This is the location where the locking tab will set after installation.
For the top-inserted/face-inserted embodiment:
   Use a T-slot bit to cut a pocket with an undercut around the perimeter of the pocket, creating a location for the protruding tab to lock after insertion.

To prepare the second panel:
Route a straight line at the proper distance from the facing edge such that when inserted, the panels will align exactly.
   The centerline this cut is ⅜″ from the surface of the panel where the first pocket was cut.
   The first cut is performed with the same T-slot bit used to create the pocket, saving time because no tool changes are required.
   The first slot should be approximately 1¼″ long and 3/16″ deep.
Next, the same T-slot bit is used to cut a path ⅜″ deep and 2¼″ long.
   Approximately one half of the slot is ⅜″ wide with the remaining one half being only 3/16″ wide. This creates a larger section for insertion of the head of the connector, and a narrower locking section.
   This action creates a T slot space that the device can slide into.

Accurate cutting is required to ensure a proper fit. But dimensions may be changed slightly to affect the tightness of a given fit.

Steps for Installation:
Insert the connector into the stepped slot, or non-stepped slot, in the first panel;
With slight downward pressure, push the connector away from the edge of the panel and into the stepped slot, keeping the device flush with the surface of the material;
   There will be resistance caused by the physical interference of the locking tab with the bottom of the stepped slot, thus downward pressure will likely be required.
When the connector is seated, the locking tab will engage or lock into the tab depression.
The device is now fully installed and ready to attach to the second panel.
The second panel is then oriented at a 90-degree angle such that the head of the connector is inserted into the second panel at the insertion section of the T-shaped slot;
The second panel is then slid, moving the head of the connector into the locking section of the T-shaped slot;
Note that the head of the connector includes raised protrusions (“ridges” or “teeth”) that create depressions in the T-shaped slot, further locking the connector in place.

To remove the device, reverse the above steps, but prior to removing the connector from the first panel:
The edge-inserted embodiment, while not permanent, is difficult to remove without proper tooling.
The top-inserted, or face-inserted embodiment, however, can be easily removed. To do so, simply insert a common screwdriver into the slot and pry back the clip holding the device in the pocket. The device can now easily be removed.

After installation, when the panels are locked into each other, the faces of the panels should align without adjustment.

As a further alternative, there is the option of flipped versions of each of the above embodiments.

The flipped versions are installed on the opposite side of the first panel. In other words, the above embodiments are installed on the inside of a cabinet, the flipped versions are installed on the outside.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a first isometric, installed, view of the panel connector.

FIG. 2 illustrates an exploded, installed, view of the panel connector.

FIG. 3 illustrates a section, installed, view of the panel connector.

FIG. 4 illustrates an isometric view of the panel connector.

FIG. 5 illustrates a second isometric view of the panel connector.

FIG. 6 illustrates a third isometric view of the panel connector.

FIG. 7 illustrates a section view of the panel connector.

FIG. 8 illustrates a top view of the panel connector.

FIG. 9 illustrates a second isometric, installed, view of the panel connector.

FIG. 10 illustrates an isometric view of a pocket of the panel connector.

FIG. 11 illustrates a section view of a pocket of the panel connector.

FIG. 12 illustrates a top, installed, view of a second embodiment of the panel connector.

FIG. 13 illustrates a section, installed, view of a second embodiment of the panel connector.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

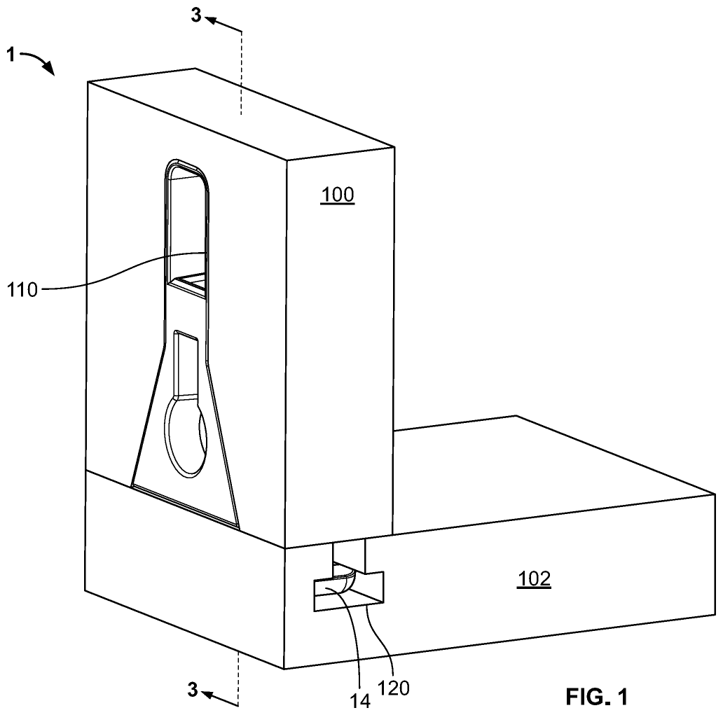

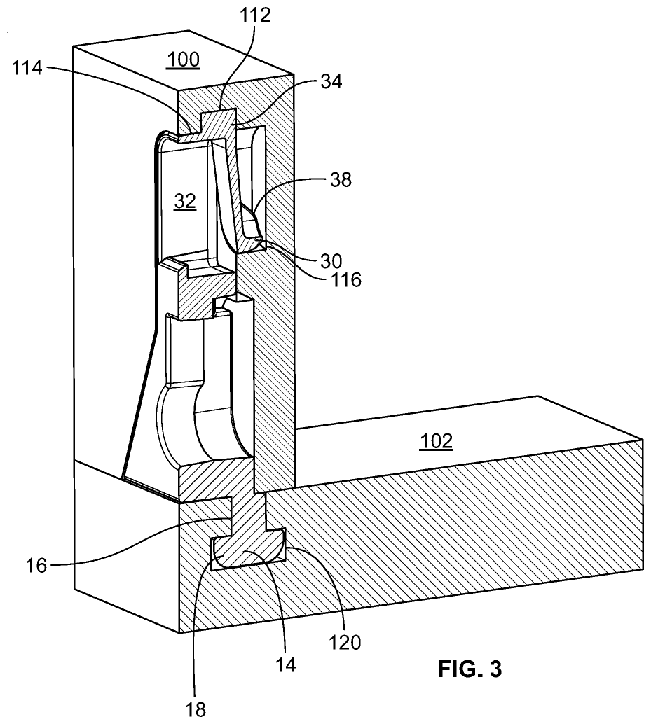

Referring to FIGS. 1-3, multiple installed views of the panel connector are shown.

The panel connector 1 bridges the first panel 100 and the second panel 102.

The body 10 of panel connector 1, with projecting rib 12, fits within the V-shaped stepped slot 110 of the first panel 100. Specifically, the narrower body 10 sits within the wide slot section 112, the projecting rib 12 sits within the narrow slot section 114.

The locking tab 30 interfaces with the tab depression 116, preventing the panel connector 1 from sliding out of the first panel 100. During insertion, the locking tab 30 can deform at the living hinge 34, the locking tab 30 moving into the compression space 32. The insertion ramp 38 guides the locking tab 30 up and over, latching into the tab depression 116.

The head 14 fits within the T-shaped slot 120 of the second panel 102. The narrow section of the T-shaped slot 120 lines up with the channel 16, the overhang 18 of the head 14 preventing the panel connector 1 from pulling out of the T-shaped slot 120.

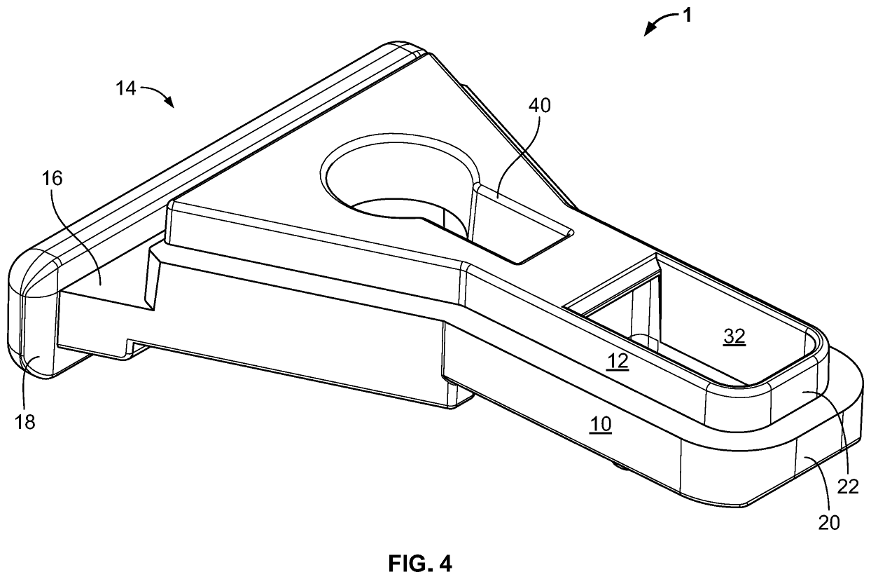

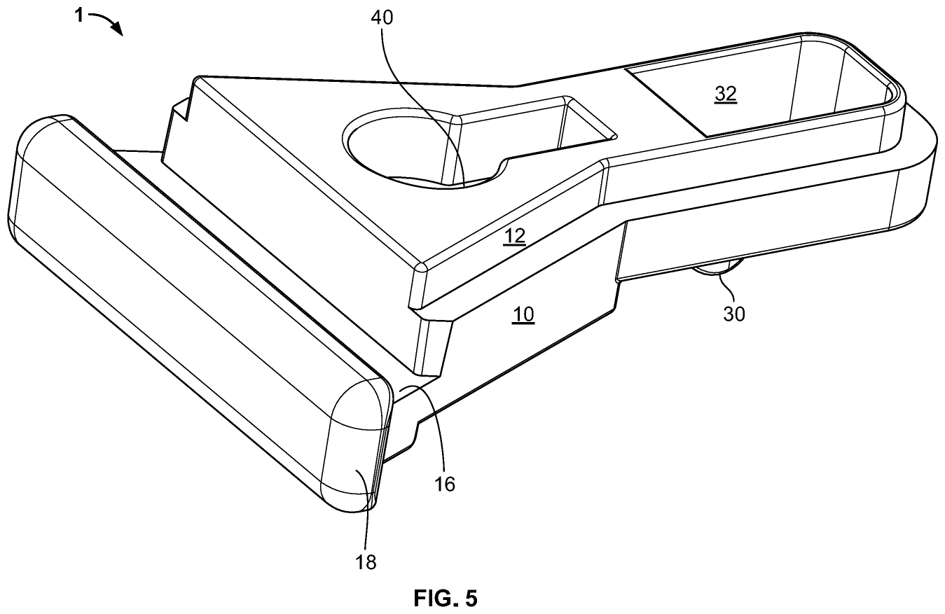

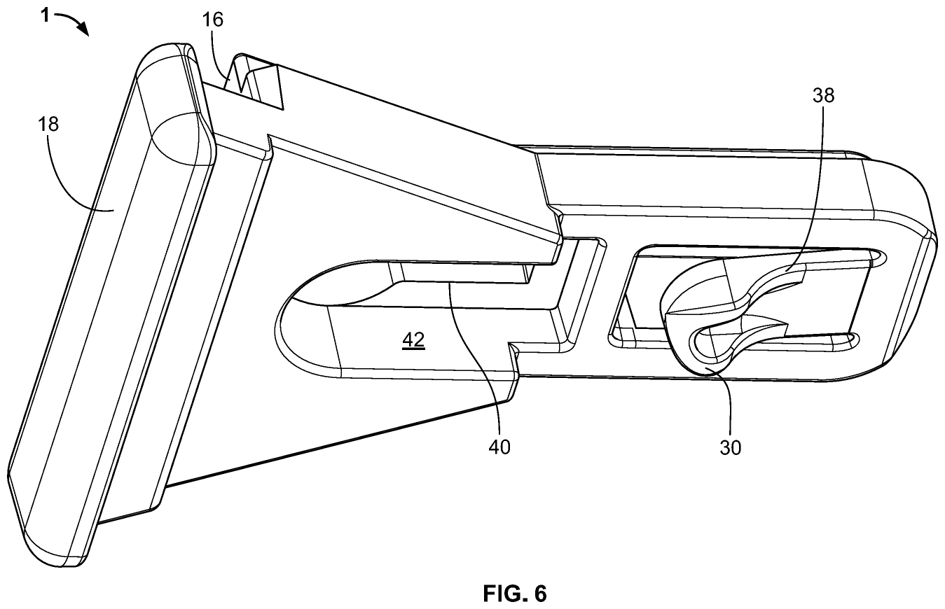

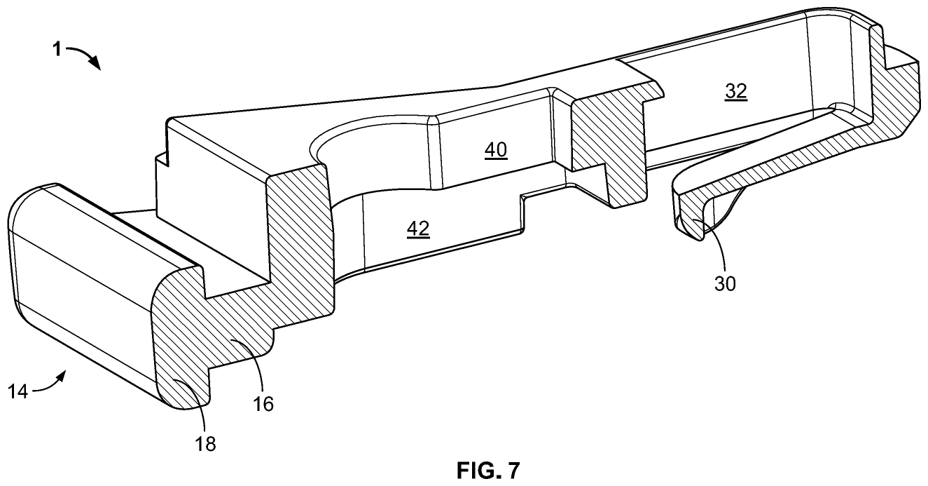

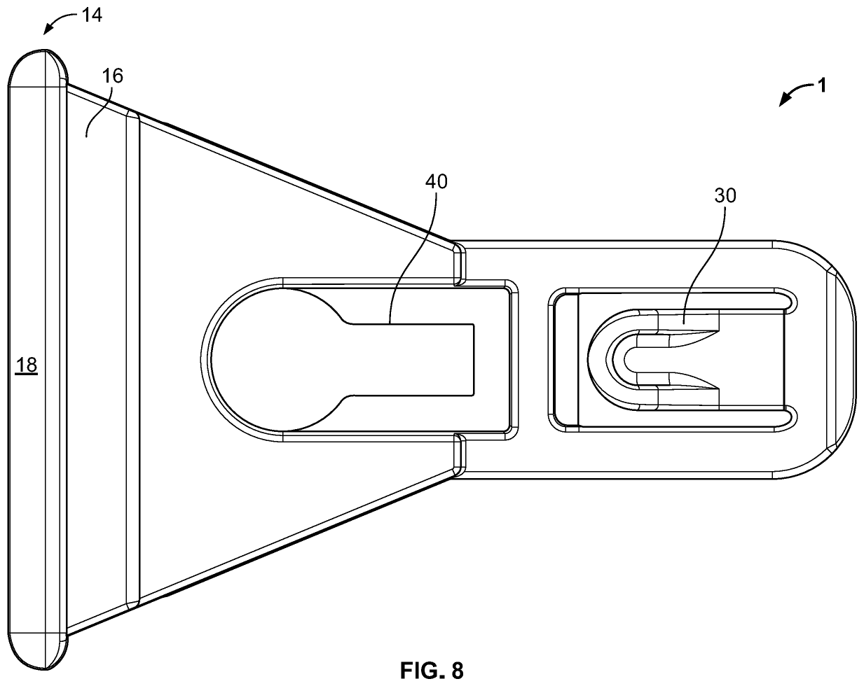

Referring to FIGS. 4-8, multiple views of the panel connector alone are shown.

The panel connector 1 is shown with body 10 and projecting rib 12, widening to a head 14. The head 14 is separated from the body 10 by a narrower channel 16, the head 14 including an overhang 18 to hold the panel connector 1 within a T-shaped slot.

The body 10 includes a body tip 20, the projecting rib 12 including a projecting rib tip 22.

The locking tab 30 can move in and out of the compression space 32 during installation, bending at a living hinge 34.

An insertion ramp 38 helps the locking tab to slide over intervening walls.

A keyhole slot 40 and keyhole void 42 allow for a secondary connector to be inserted and locked into the panel connector 1, allowing for the connection of additional devices. For example, feet for a cabinet, drawer front mounting hardware, or brackets for attaching molding.

In this embodiment, the edge-inserted embodiment, the body 10 tapers away from the head 14, resulting in a narrower body tip 20 as compared to the head 14.

This direction of taper allows for insertion of the panel connector 1 into a panel edge.

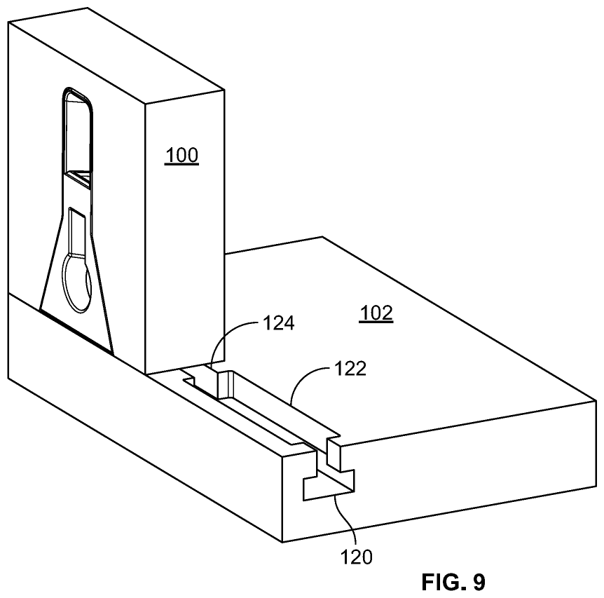

Referring to FIG. 9, a second isometric, installed, view of the panel connector is shown.

The first panel 100 and the second panel 102 are shown, with the T-shaped slot 120 including an insertion section 122 and a locking section 124.

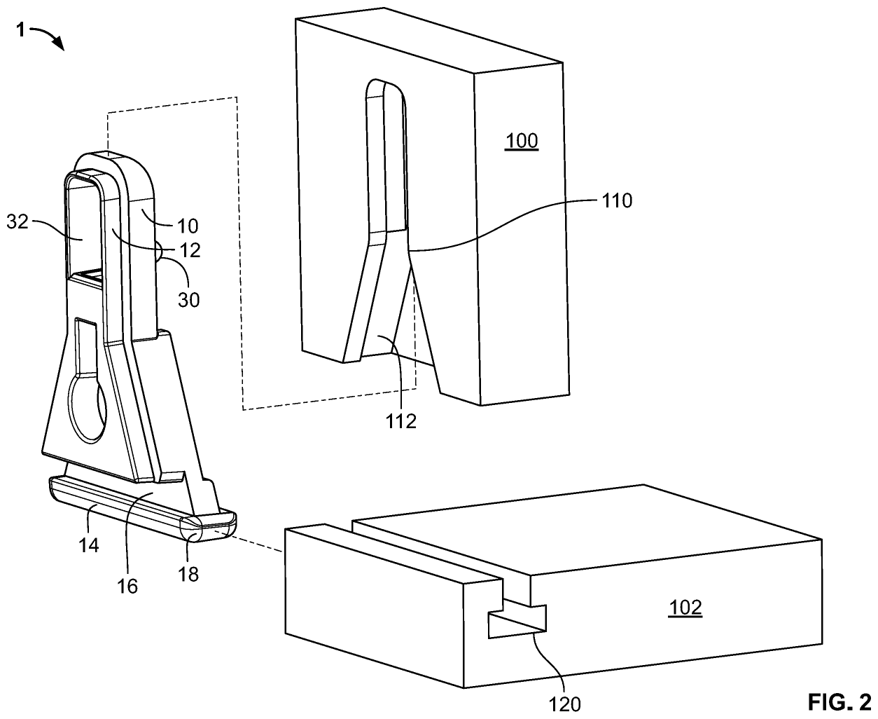

The head 14 (see FIG. 2) of the panel connector 1 is inserted into the insertion section 122, the panel connector 1 then slid down the T-shaped slot 120, until locked within the locking section 124.

This process provides an alternative means of assembly, where the panel connector 1 is first placed into the first panel 100, then slid into the second panel 102.

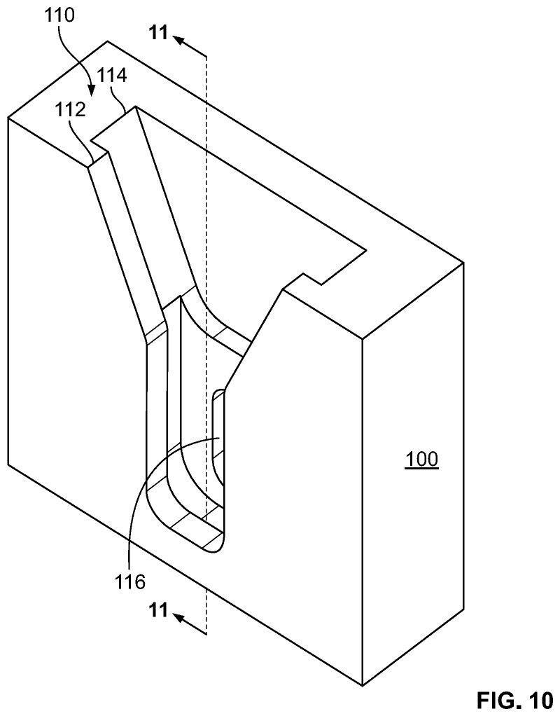

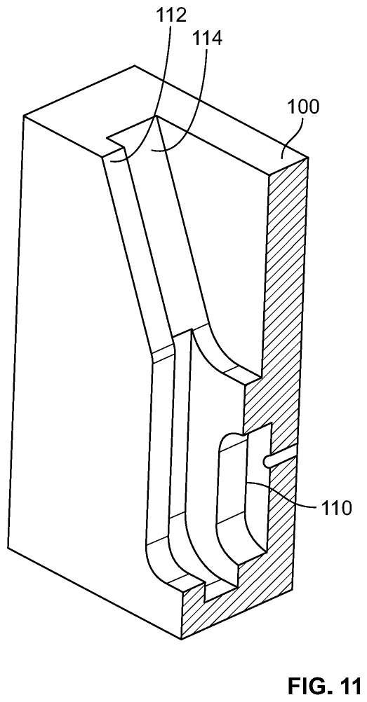

Referring to FIGS. 10 and 11, an isometric view and section view of a pocket of the panel connector are shown.

The pocket is a V-shaped stepped slot 110 with a wide slot section 112 and a narrow slot section 114. A tab depression 116 holds the locking tab 30 (see FIG. 2) of the panel connector in place.

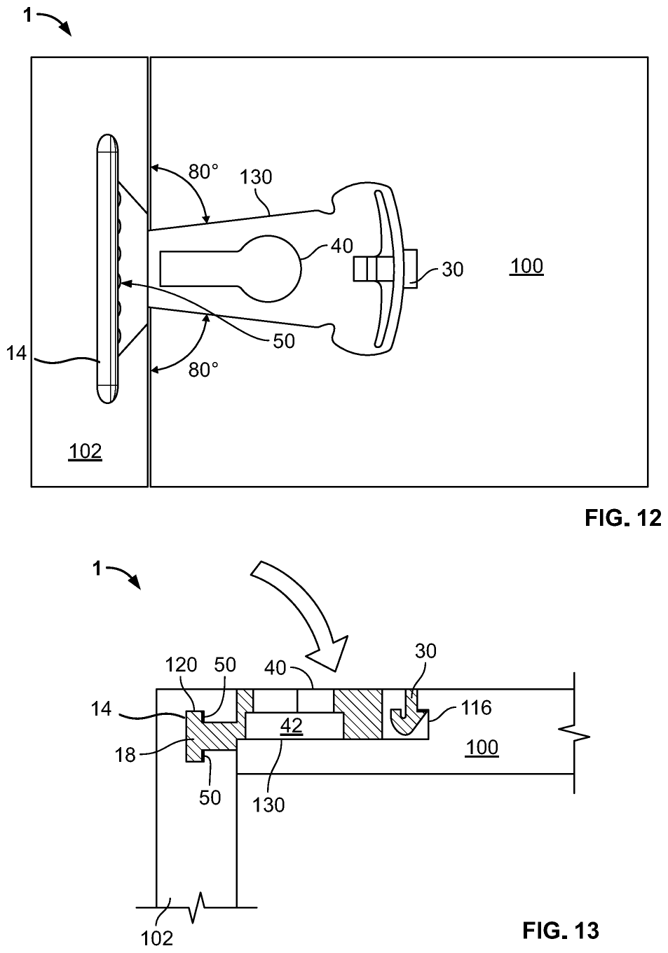

Referring to FIGS. 12 and 13, a top and section view, installed, of a second embodiment of the panel connector are shown.

The second embodiment of the panel connector 1 includes a projecting rib 12 which includes the thickness of the body 10 but without the projection. The body 10 is reduced to the same shape and size as projecting rib 12, making the sides flat. The tab depression/slot 116 continues around the perimeter of the pocket but is only used at the tip to serve as a latch for locking tab 30.

With the taper reversed, the projecting rib 12 can pivot from the edge, using a guiding protrusion, downward into pocket 130 from the top, rather than being slid into the edge. The panel connector 1 seats into the pocket 130, the locking tab 30 snaps into the tab depression 116, locking the panel connector 1 in place.

The body 10 necks down between the head 14 and body 10, preventing the body 10 from being pulled out of the edge of the first panel 100.

Further shown are optional teeth 50. The teeth 50 lock into the material of the second panel 102, minimizing sliding of the panel connector 1 inside the T-shaped slot 120.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A panel connector for joining a first panel and a second panel, the panel connector comprising:
a body and a head;
the body having a body length, a body width, and a body thickness;
the head having a head length, a head width, and a head thickness;
the body width decreasing along the body length;
the body forming a tapered shape for insertion into a tapered slot in the first panel;
the tapered shape preventing the body from sliding out of the tapered slot in the first panel;
the head protruding from the body;
the head including an overhang, the overhang protruding in a direction perpendicular to the body;
the head for insertion into a T-slot in the second panel;
whereby the panel connector joins the first panel and the second panel, maintaining an orientation of the first panel with respect to the second panel.

2. The panel connector of claim 1, wherein the body is substantially V-shaped, generally narrowing away from the head.

3. The panel connector of claim 1, wherein the body is substantially V-shaped, generally widening away from the head.

4. The panel connector of claim 1, wherein the head width is greater than the body width.

5. The panel connector of claim 1, further comprising:
a projecting rib;
the projecting rib protruding outwardly from the body;
the projecting rib being narrower than the body;
whereby when installed, the body locks into a wide slot section of the first panel, and the projecting rib locks into a narrow slot section, thus preventing the panel connector from popping out of the first panel.

6. The panel connector of claim 1, further comprising:
a locking tab joined to the body;
the locking tab interfacing with a tab depression in the first panel;
the locking tab preventing the panel connector from sliding out of the tapered slot;
whereby the panel connector is installed by sliding into the tapered slot, the locking tab snaps into the tab depression, and a reverse-sliding motion is avoided.

7. The panel connector of claim 5, further comprising:
a locking tab joined to the body;
the locking tab interfacing with a tab depression in the first panel;
the locking tab preventing the panel connector from sliding out of the tapered slot;
whereby the panel connector is installed by sliding into the tapered slot, the locking tab snaps into the tab depression, and a reverse-sliding motion is avoided.

8. A connector for connecting a first panel and a second panel, the connector comprising:
a body;
the body tapering along its length, the body shaped to fit into a tapered slot in the first panel;
a head;
the head including one or more perpendicular overhangs that increase a height of the head;
the one or more overhangs locking the head into a slot in the second panel;
the head protruding away from the body;
whereby the connector spans the first panel and second panel, holding the first panel and second panel in a fixed position.

9. The connector of claim 8, wherein the body is substantially V-shaped, narrowing away from the head.

10. The connector of claim 8, wherein the body is substantially V-shaped, generally widening wider away from the head.

11. The connector of claim 8, wherein a head width is greater than a body width.

12. The connector of claim 8, further comprising:
a projecting rib;
the projecting rib protruding outwardly from the body;
the projecting rib being narrower than the body;
whereby when installed, the body locks into a wide slot section of the first panel, and the projecting rib locks into a narrow slot section, thus preventing the connector from popping out of the first panel.

13. The connector of claim 8, further comprising:
a locking tab joined to the body;
the locking tab interfacing with a tab depression in the first panel;
the locking tab preventing the connector from sliding out of the tapered slot;
whereby the connector is installed by sliding into the tapered slot, the locking tab snaps into the tab depression, and a reverse-sliding motion is avoided.

14. The connector of claim 12, further comprising:
a locking tab joined to the body;
the locking tab interfacing with a tab depression in the first panel;
the locking tab preventing the connector from sliding out of the tapered slot;
whereby the connector is installed by sliding into the tapered slot, the locking tab snaps into the tab depression, and a reverse-sliding motion is avoided.

15. A connector for joining a first panel and a second panel, the connector comprising:
a first section that slides into a routed depression, the routed depression in the first panel;
a second section that slides into a T-slot;
the T-slot in the second panel;
whereby the connector holds the first panel in a position with respect to the second panel.

16. The connector of claim 15, wherein the first section is substantially V-shaped, narrowing away from the second section.

17. The connector of claim 15, wherein the first section is substantially V-shaped, generally widening away from the second section.

18. The connector of claim 15, further comprising:
a projecting rib;
the projecting rib protruding outwardly from the first section;
the projecting rib being narrower than the first section;
whereby when installed, the first section locks into a wide slot section of the first panel, and the projecting rib locks into a narrow slot section, thus preventing the connector from popping out of the first panel.

19. The connector of claim 15, further comprising:
a locking tab joined to the first section;
the locking tab interfacing with a tab depression in the first panel;
the locking tab preventing the connector from sliding out of the routed depression;
whereby the connector is installed by sliding into the routed depression, the locking tab snaps into the tab depression, and a reverse-sliding motion is avoided.

20. The connector of claim 18, further comprising:
a locking tab;
the locking tab interfacing with a tab depression in the first panel;
the locking tab preventing the connector from sliding out of the routed depression;
whereby the connector is installed by sliding into the routed depression, the locking tab snaps into the tab depression, and a reverse-sliding motion is avoided.
